(19) United States
(12) Patent Application Publication
(10) Pub. No.: US 2004/0216130 A1
(43) Pub. Date: Oct. 28, 2004

(54) Method for saving and restoring data in software objects

(76) Inventors: S. Brandon Keller, Evans, CO (US); Gregory Dennis Rogers, Fort Collins, CO (US); George Harold Robbert, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/231,528

(22) Filed: Aug. 30, 2002

(51) Int. Cl. G06F 9/44

(52) U.S. Cl. 719/315

(57) ABSTRACT

A method for saving and automatically restoring data contained in an object in an object-oriented software environment. The method creates a ‘checkpoint object’ with a pointer to the object of interest, and a copy of the fields in the storage object that are to be saved. After a system user has completed modifications to data values in the object, the checkpoint object is destroyed, which automatically causes all of the data values in the storage object to be restored to their original states.

### TECHNICAL FIELD

The present invention relates generally to computer systems, and more particularly, to a method for saving and automatically restoring data in a computer system employing object-oriented software.

### BACKGROUND

When handling stored information in an object-oriented software system, software developers often need to save some or all of the data values contained in a data storage object, so that the values can be restored to their original states after they have been modified. In order to provide a data checkpoint for a data storage object (or simply ‘storage object’), previously existing methods typically assign variables to contain copies of each individual data value to be saved, store the data values in the corresponding variables, and restore the values to the original checkpoint values after all changes to the data have been made. Alternatively, a complete backup copy of the data storage object is made, and the working version of the storage object is replaced with the entire backup copy after making changes to the data in the storage object.

The latter method requires copying the entire contents of the data storage object, and both of these methods require the developer to remember to reset the data values after all changes to the original data have been completed.

### SUMMARY

The disclosed method provides a system that saves the status of a data storage object and automatically restores the saved state after the original data has been modified.

In one embodiment, a ‘checkpoint object’ is created within a user function, with a pointer to the data storage object of interest. Next, the data fields to be saved are registered with the checkpoint object. The checkpoint object then saves the registered fields in temporary storage. After a function used by a software developer or other system user has completed all modifications to data values in the storage object, the checkpoint object for that function is destroyed by a ‘destructor’ mechanism, which automatically causes all of the data values in the data storage object to be restored to their original states.

The C++ programming language supports the concept of the ‘destructor’ method designed to allow ‘garbage collection’ (memory cleanup) after a function has completed its usefulness. The primary purpose of a destructor is memory de-allocation, the point at which memory ‘leaks’ can best be avoided. A non-obvious aspect of the present method is that it uses a destructor, or the equivalent thereof, for a purpose other than memory de-allocation.

The present method also automatically restores the checkpointed data if some error or inadvertent situation causes a program to malfunction, causing the checkpoint object to go out of scope.

### BRIEF DESCRIPTION OF THE DRAWINGS

FIG. 1 is a diagram illustrating exemplary software components in an object-oriented system with which the present method is used; and

FIG. 2 is a flowchart illustrating exemplary steps which may be performed in practicing one embodiment of the present method.

### DETAILED DESCRIPTION

The present method operates in an object-oriented software programming environment to save and automatically restore the status of an object (‘data storage object’) used for data storage. The method utilizes a ‘checkpoint’ object to allow a software developer or other system user using an object-oriented programming language, such as C++, to save or ‘checkpoint’ the state of specified data stored in an object, modify the data, and have the data automatically restored to its initial state after the data has been modified.

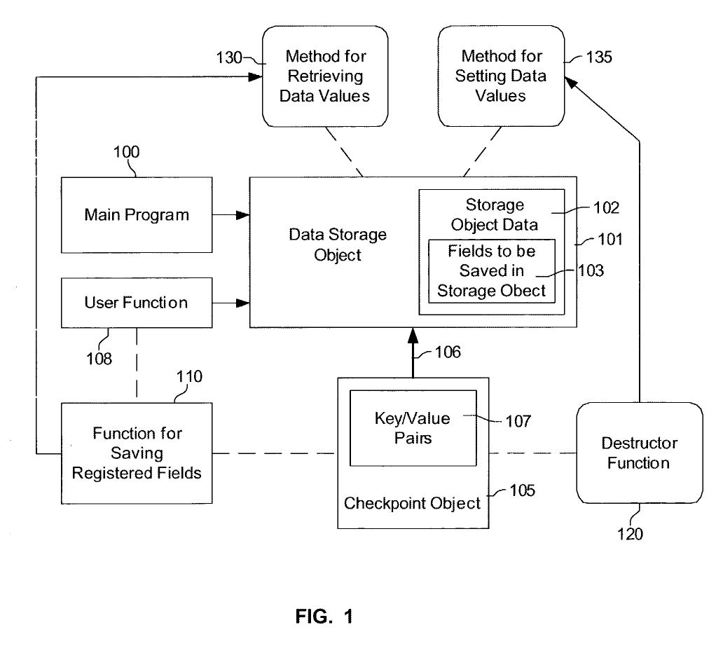

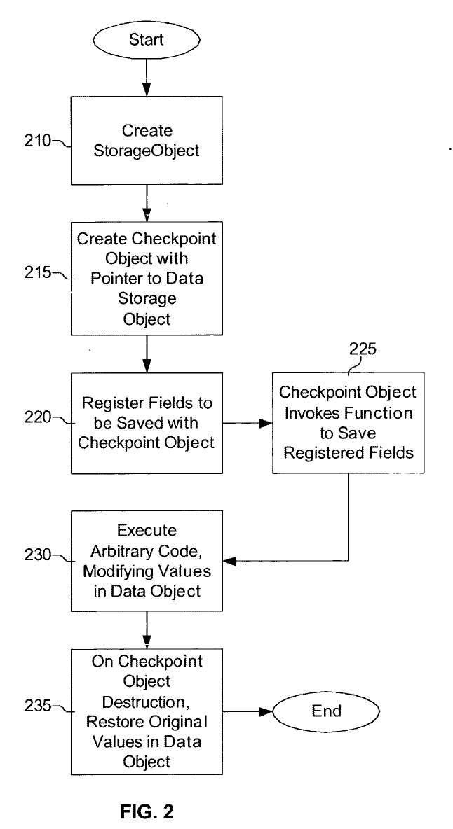

FIG. 1 is a diagram illustrating exemplary software components in an object-oriented system with which the present method is used. FIG. 2 is a flowchart illustrating a sequence of exemplary steps performed in practicing one embodiment of the present invention. Operation of the present method is best understood by viewing FIGS. 1 and 2 in conjunction with one another. Implementation of the present method requires the existence of, (or creation of) utility functions for setting/modifying and retrieving values of data stored in, or associated with, the data storage object 101. These functions are shown in FIG. 1 as functions 130 and 135, respectively. The FIG. 2 flowchart assumes that, at some point prior to operation of the present method, the necessary object classes and functions have been declared. These objects/functions are described in detail below with respect to Table 1.

As shown in FIGS. 1 and 2, at step 210, a data storage object 101 is created. The term “data storage object” is meant to indicate that the particular object has data 102 associated therewith; the object does not necessarily have to be used primarily for the storage of data. In many instances, data storage object 101 will already exist, and therefore will not need to be created at this point.

At step 215, a checkpoint object 105 is created within a user function 108, with a pointer 106 to the data storage object 101. As part of the code for the checkpoint object, a program developer or other user creates a function 120 termed a ‘destructor’, which in the present case, is a method on the ‘checkpoint’ object class, which has been previously declared. In the C++ programming language, object classes each have a method called the ‘destructor’ which is called when the object is destroyed. Objects can be destroyed by going out of scope, or by being explicitly deleted by the programmer. As explained below with respect to step 230, an exit taken from the user function 108 causes the checkpoint object 105 to go out of scope, which in turn causes execution of the checkpoint class destructor.

In other object-oriented programming languages, a functionally analogous ‘destructor’-type mechanism may be implemented to restore changed data values on successful exit from a function. All that is needed is a mechanism to force a code block to be executed on exit from a function. For example, after any ‘try’ block in the Java programming language, a ‘finally’ block can be specified. The ‘finally’ block will execute, no matter how the ‘try’ block exits—either normally or exceptionally. In general, a ‘close’ method, called at the end of a user function, may be employed to provide a functional equivalent for the C++ destructor. The destructor function may exist, for example, in a library, prior to the present step.

At step 220, the specific data fields 103 to be checkpointed (i.e., saved) are registered with the checkpoint object 105. These data fields 103 include all of the data items stored in the data storage object 101 that are likely to be modified during a particular program development or testing session.

At step 225, checkpoint object invokes ‘save’ function 110 to save a copy of the registered data fields 103 in temporary storage 107 in the checkpoint object 105. In an exemplary embodiment of the present method, these data fields 103 are stored as key/value pairs. The data fields 103 to be saved will typically constitute a subset of the data 102 associated with a given data storage object 101, thus simplifying the checkpointing procedure in contrast to previous methods that save all of the data in the storage object.

At step 230, a user function 108 then executes arbitrary code, which includes operations that modify some or all of the values of the data 103 associated with data storage object 101, the values of which have been saved in temporary storage 107.

Finally, at step 235, after the system user has completed all modifications to data values in the data storage object 101, execution of the return in user function 108 causes the checkpoint object 105, which is within the scope of the user function, to go out of scope. The destructor for the ‘checkpoint’ class is then automatically invoked, which causes all of the data values in the storage object 101 to be restored to their original states. More specifically, the destructor function 120 is coded to retrieve the data values for each of the fields saved in temporary storage 107 in the checkpoint object 105, using the key/value pairs stored therein. After retrieval, the respective fields 103 in the data storage object 101 are then restored to their original values using the retrieved data values.

The user function does not change the stored values as seen by the calling function (main program) 100 because a checkpoint object 105 is created by user function 108 before the data 102 in the storage object was modified. Thus, when the checkpoint object is destroyed at the end of the user function call, the saved values are restored, and the main program never sees any of the changes.

An example of a working environment in which the present method may be utilized is shown below. The example reflects a typical situation in which a CAD tool is employed for circuit design. In this example, assume that there is a storage object (‘Params’) 101 that is loaded with various types of information, such as process information, environment information, and configuration information, etc. This object can be passed to practically any function that performs a particular task. The code inside each of these functions may need to change the values stored in the Params object briefly, as the hierarchy of the circuit design is traversed. If there were only one value that needed to be modified, a corresponding variable could be created and modified, leaving the contents of the Params object intact. However, note that the Params object has a nested hierarchy of values. That is, there may be have several key=>data pairs, such as:

“block_name”=>“”;

“blockdir”=>“”;

“output_dir”=>“<blockdir>/output”;

When the code is executing, “blockdir” might, for example, be set equal to the path to a block of name “block_name”:

“blockdir”=>“arbitrary_path/<blockname>”;

If blockname is then set, the Params object will cascade the changes through the other fields they are accessed:

“block_name”=>“my_block1”;

“block_dir”=>“arbitrary_path/my_block1”;

“output_dir”=>“arbitrary_path/my_block1/output”;

Thus, it can be seen that simply using a variable to save values does not provide the cascading updated field values. All of the code that called these functions that perform tasks, and particularly the various functions themselves, do not expect to see the data stored in the Params object change. Therefore, a checkpoint object 105 is created at the beginning of every function that calls Params, which saves the values that are to be modified. Note that only the items that need to be saved are the items that are explicitly modified (ie., block_name and blockdir), as opposed to the items that are cascaded (ie., output_dir). Thus, when the user function 108 exists, everything that was changed by the function is reset, and all other code can see the unchanged Params object.

Table 1, below, illustrates a simplified exemplary main program, a checkpoint object, and related functions and declarations. Each section of source code in the table is prefaced with a character in brackets, as follows:

[A] Storage object class declaration

[B] Checkpoint object class declaration

[C] Function (of object ‘Storage’) for retrieving values [GetValue 130]

[D] Function (of object “Storage”) for setting values [SetValue 135]

[E] Function (of object “Checkpoint”) for saving storage object data values in temporary storage [Save 110 ]

[F] Destructor function [120] for checkpoint object

[G] User function for manipulating storage object data; creates checkpoint object; calls [E]; may call other [G]-type functions

[H] Main program; calls user function(s)

As shown in Table 1, in section [H], a user program [‘main’] 100 creates a data storage object ‘store’ 101. The ‘main’ program 100 can be any function. The declaration for the storage object class is shown in section [A]. Next, some initial data 102 is generated and stored in the storage object. Note that the storage object 101 and the data 102 stored therein could be generated previously, and/or by another program. One or more ‘user functions’ 108 are then called from the main program. Each of these user functions 108 has similar functionality insofar as each function uses a checkpoint object to save data values that need to be restored upon exit of the respective function. It should be noted that all of the program/function names used in the example in Table 1, as well as in FIGS. 1 and 2, are arbitrary.

As shown in section [G], the user function ‘UserFunction’ 108 creates a checkpoint object (‘saver’) 105, with a pointer (‘pStore’) 106 to the data storage object 101. Section [B] is the declaration for the checkpoint object class. Typically, the functionality in the example user function 108 may be used in other functions operating on a given data storage object to ensure that the state of the storage object is maintained from function to function. User function 108 then uses the checkpoint object 105 to call a function (‘save’) 110 for saving storage object data values in temporary storage 107. When ‘saver.Save(‘x’)’ is executed, the checkpoint object invokes a ‘pStore->GetValue(‘x’)’ for each saved item ‘x’, and when the Checkpoint object is destroyed, it will do a ‘pStore->SetValue(‘x’, ‘old_value’)’ of the old values.

The ‘save’ object 110, shown in section [E] is an existing function or method which is a feature of the ‘checkpoint’ object 105. This object receives the passed parameters to be saved (in the present example, “key_{—}1” and “key_2”), creates a temporary copy 107 of the data, and stores it in the storage object 101.

As shown in sections [C] and [D], ‘GetValue’ 130 and ‘SetValue’ 135 are existing methods (functions) on the data storage object 101. These methods are required for any object that is to be checkpointed. The checkpoint object ‘Save’ 110 calls ‘GetValue’ 130 for each saved item and saves the item and its value in the ‘saved_values’ container, and when the checkpoint object is destroyed, its associated destructor 120 calls ‘SetValue’ 135 to restore the original data values in the storage object 101.

The Destructor Function 120 for the CheckPoint object 105 is shown in section [F]. In the present example, the data values in the storage object are reset on return in the internal destructor code for the Checkpoint object. Note that ‘saved_values’ is an associative container wherein the ‘Save’ function 110 has stored the original states of the variables ‘key_{—}1’ and ‘key_{—}2’ in the present example. As indicated above, the destructor is a special method or member function of a class which always executes automatically whenever an object goes out of scope.

```
TABLE 1
//[A]
class StorageObject {
    public:
        const string &GetValue(const string &key) const;
        void SetValue(const string &key, const string &value);
    private:
        map<string, string> internal_storage;
};
//[B]
class CheckPoint {
    public:
        void Save(const string &key);
        CheckPoint(StorageObject *pStorage) {pStorage_object =
        pStorage;}
        ˜CheckPoint( );
    private:
        StorageObject *pStorage_object;
        map<string, string> saved_values; };
//[C]
// Function for retrieving data values
const string &
StorageObject::GetValue(
    const string &key) const
{
    static const string NULL_STR = “”;
    map<string, string>::const_iterator lookup;
    lookup = internal_storage.find(key);
    if (lookup != internal_storage.end( )) {
        return lookup->second;
    }
    return NULL_STR;
}
//[D]
// Function for setting data values
void
StorageObject::SetValue(
    const string &key,
    const string &value)
{
    internal_storage[key] = value;
    return;
}
//[E]
// The function for saving registered fields
void
CheckPoint::Save(
    const string &key)
{
// Save storage object values in temporary storage
    string value = pStorage_object->GetValue(key);
    saved_values[key] = value;
    return;
}
//[F]
//The Destructor Function for CheckPoint
CheckPoint::˜CheckPoint( )
{
    map<string, string>::iterator i;
    for (i = saved_values.begin( ); i != saved_values.end( ); i++)
    {
        pStorage_object->SetValue(i->first, i->second);
    }
}
//[G]
// This function operates on the storage object.
void UserFunction(
    StorageObject *pStore)
// Create the checkpoint object (“saver”), which calls a function (“save”)
for saving storage object data values in temp. storage.
{
    CheckPoint saver(pStore);
// Register the data fields to be saved with the checkpoint object
    saver.Save(“key_1”);
    saver.Save(“key_2”);
// Now the data may be modified
    pStore->SetValue(“key_1”, “modified_value_1”);
    pStore->SetValue(“key_2”, “modified_value_2”);
// Note that the values stored in the storage object were changed by the
child function; i.e., in the present example, “initial_value_1” was
changed to “modified_value_1”, and “initial_value_2” was changed
to “modified_value_2”.
// On return from this function, CheckPoint's destructor is called.
    return;
}
//[H]
int main( )
{
// Create the storage object “store”.
    StorageObject store;
// Generate some initial data and store in the storage object. store.
SetValue(“key_1”, “initial_value_1”);
    store.SetValue(“key_2”, “initial_value_2”);
// Call a user function to manipulate data in the storage object
    UserFunction(&store);
        //At this point, the modified data values have been restored to
their initial values on return from UserFunction, via the destructor function
for the checkpoint object class declared within the UserFunction.
    return 0;
}
```

END OF TABLE

What is claimed is:

1. A method for automatically saving and restoring data contained in a data storage object in an object-oriented software environment, comprising the steps of:
creating a checkpoint object within a user function;
registering, with the checkpoint object, data fields in the storage object that are to be modified;
creating a temporary copy of the fields in the storage object, including data values for the fields, that are to be modified by said user function; and
restoring the data values in the data storage object to their original states, using the data values stored in said temporary copy, when an exit is taken from the user function, after the data values of the fields in the storage object have been modified.

2. The method of claim 1, wherein said temporary copy of the fields that are to be modified is stored in the checkpoint object.

3. The method of claim 2, wherein said temporary copy of the fields that are to be modified are stored as key/value pairs.

4. The method of claim 1, including the additional step of creating a destructor function for the checkpoint object to restore said data values.

5. The method of claim 4, wherein the destructor function comprises a function which executes when an exit is taken from the user function.

6. The method of claim 4, wherein the destructor function is executed when the checkpoint object goes out of scope.

7. The method of claim 6, wherein the object-oriented software environment executes C++ language instructions, and wherein the destructor function is a class destructor.

8. A system for automatically saving and restoring data contained in a data storage object in an object-oriented software environment, comprising:
a checkpoint object having a pointer to the data storage object, for creating a copy of fields in the data storage object, including associated data values, that are to be modified; and
a destructor function invoked after modifications to the data values in the storage object are completed, to thereby cause all of the data values in the data storage object to be restored to their original states.

9. The system of claim 8, further comprising functions for saving and retrieving said data values.

10. The system of claim 9, wherein said copy in the checkpoint object includes key/value pairs of said fields in the data storage object that are to be modified, for identifying the data values in the data storage object to be restored.

11. The system of claim 8, wherein the checkpoint object is created within a user function.

12. The system of claim 11, wherein the destructor function is executed when the checkpoint object goes out of scope.

13. The system of claim 11, wherein the destructor function comprises a function which executes when an exit is taken from the user function.

14. The system of claim 11, wherein the user function registers, with the checkpoint object, the data fields in the storage object that are to be modified.

15. A method for automatically saving and restoring data contained in a data storage object in an object-oriented software environment, comprising the steps of:
creating a checkpoint object with a pointer to the data storage object;
creating a destructor function for the checkpoint object class;
creating a temporary copy of data fields in the storage object that are to be modified, including data values associated therewith; and
restoring all of the data values in the data storage to the data values stored in said temporary copy, using the destructor function, after the data values of the fields in the storage object have been modified.

16. The method of claim 15, wherein a copy of the fields that are to be modified is saved in the checkpoint object as a set of key/value pairs.

17. The method of claim 15, wherein the destructor function comprises a member function of the checkpoint object class which executes automatically whenever the checkpoint object goes out of scope.

18. The method of claim 15, including the additional step of registering, with the checkpoint object, fields in the data storage object that are to be modified.

19. The method of claim 18, wherein a copy of the fields that were registered is saved in the checkpoint object.

20. The method of claim 15, wherein the checkpoint object is created within a user function.

21. A system for automatically saving and restoring data contained in a data storage object in an object-oriented software environment, comprising:
means for creating a checkpoint object within a user function;
means for registering, with the checkpoint object, data fields in the storage object that are to be modified;
means for creating a temporary copy of the fields in the storage object, including data values for the fields, that are to be modified by said user function; and
means for restoring the data values in the data storage object to their original states, using the data values stored in said temporary copy, when an exit is taken from the user function, after the data values of the fields in the storage object have been modified.
